(19) United States
(12) Patent Application Publication
(10) Pub. No.: US 2023/0222773 A1
(43) Pub. Date: Jul. 13, 2023

(54) METHOD FOR PREDICTING GEOLOGICAL FEATURES FROM BOREHOLE IMAGE LOGS

(71) Applicant: SHELL OIL COMPANY, Houston, TX (US)

(72) Inventors: Pedram ZARIAN, Houston, TX (US); Oriol FALIVENE ALDEA, Houston, TX (US)

(21) Appl. No.: 17/999,994

(22) PCT Filed: Jun. 22, 2021
(86) PCT No.: PCT/EP2021/066949

§ 371 Date: Nov. 28, 2022

Related U.S. Application Data
(60) Provisional application No. 63/043,655, filed on Jun. 24, 2020.

(51) Int. Cl. G06V 10/774; G01V 99/00; G06V 10/82

(52) U.S. Cl. CPC G06V 10/774; G01V 99/005; G06V 10/82

(57) ABSTRACT

A method for predicting an occurrence of a geological feature in a borehole image log using a backpropagation-enabled process trained by inputting a set of training images (12) of a borehole image log, iteratively computing a prediction of the probability of occurrence of the geological feature for the set of training images and adjusting the parameters in the backpropagation-enabled model until the model is trained. The trained backpropagation-enabled model is used to predict the occurrence of the geological features in non-training borehole image logs. The set of training images may include non- geological features and/or simulated data, including augmented images (22) and synthetic images (24).

### FIELD OF THE INVENTION

The present invention relates to a method for predicting the occurrence of geological features in borehole image logs.

### BACKGROUND OF THE INVENTION

Borehole image logs are important for hydrocarbon exploration and production. Borehole image logs are obtained by well logging tools that directly measure a physical property of the wellbore. These tools contain one or multiple sensors that scan the walls of the wellbore yielding measures across multiple azimuthal positions. The tools can provide measurements based on different types of energy sources (such as electrical, acoustic or nuclear). By moving these tools across multiple depths in the wellbore, a high-resolution image of the walls of the borehole can be obtained. The images represent the surface of the borehole, which can be approximated to a cylindrical shape. By unfolding this cylinder, a two-dimensional image can be obtained (with the horizontal axis being azimuth and the vertical axis being depth), commonly referred to as a borehole image log. Alternatively, one can interpolate the physical properties measured in the walls of borehole to generate a three-dimensional cylindrical volume with the borehole image properties.

Borehole image logs can provide insights on geological features (sedimentary and structural) that are tied to the presence of rocks that can host and economically produce hydrocarbons. For example, studying the vertical and lateral associations of sedimentary features within one or multiple wellbores can help determine the depositional environment (i.e. the environment in which the rocks were deposited), as well as reconstruct or model the geometries of the sedimentary bodies; which control the extension, location and quality of the hydrocarbon reservoirs.

Borehole image logs can be affected by numerous artefacts during data acquisition processes (e.g., stick and pull), data processing, or geomechanical (related to different types of borehole failures), resulting in creation of non-geological features. These non-geological features make the identification of geological features more difficult.

Prediction or identification of geological features (such as sedimentary facies) within borehole image logs is a significant part of the interpretation of borehole image logs. The geological features or groups of geological features that can be interpreted in the borehole image logs are often referred to as borehole image facies.

Conventionally, the identification of geological features or facies within borehole image logs is performed manually, a process that is time-consuming, requires specialized knowledge, and is prone to individual bias and/or human error. As a result, the interpretation of borehole image logs is expensive and may have inconsistent quality and format. For example, the identification of geological features from borehole image logs may take an experienced geologist multiple days or weeks to complete, depending on the physical length and quality of the borehole image logs, as well as the geological complexity.

However, backpropagation-enabled trained processes offer the opportunity to speed up and standardize the interpretation of borehole image logs.

US2017/0286802A1 (Mezghani et al.) describes a process for automated descriptions of core images and borehole images. The process involves pre-processing a borehole image to fill in missing data and to normalize image pixel attributes. Several statistical attributes are computed from the image values (such as maximum intensity, standard deviation of the intensity or intensity contrasts between neighboring pixels). These statistical attributes capture properties related to the rock characteristics. These attributes are then compared to descriptions made by geologists in order to associate certain values or ranges for each of the attributes to specific classes in order to describe a borehole image log. Mezghani et al. propose to use a multi-point statistics algorithm that takes into account the general vicinity of the affect area to generate artificial rock images to fill in, by interpolation, the missing portions of the image, thereby remedying the artefacts. Application to non-described borehole image logs then implies computing the statistical attributes and using the trained model to produce an output core description.

Conventional techniques, such as described by Mezghani et al. are limited by the fact that the attributes computed are very simple and therefore difficult to transfer to a variety of geological features with multiple appearances and non-geological artefacts. It is also limited by the fact that each type of geologic feature to be described requires a specific combination of attributes and is therefore difficult to generalize. Further, this technique does not use a backpropagation-enabled process to adjust the training classifier based on the statistical attributes.

Gong et al. (WO2020/084387A1) discloses a method for the prediction of sand fractions from borehole image logs using convolutional neural networks that automatically classify images into a set of categories. Each training image used to train their convolutional neural networks is associated with one category or label corresponding to sand fraction values based on core analysis. The method includes an optional data augmentation step before labelling, which includes manipulating the training images by randomly modifying the azimuth of the image, and randomly modifying the dip of the image, which in borehole image logs corresponds to shifting the pixels of the image according to a sinusoid curve.

However, inferences obtained by this method are limited to the quantification of one-dimensional sand fractions (i.e. a sand fraction for each depth or image in the borehole image log), rather than the extraction of geological and non-geological features for facies classification in borehole image logs.

Valentin et al. (“A deep residual convolutional neural network for automatic lithological facies interpretation in Brazilian pre-salt oilfields wellbore image logs” J Pet Sci Eng 179: 474-503; 2019) describe automatic classification of facies from borehole image logs using a deep residual convolutional neural network trained using exclusively ultrasonic (or acoustic) and resistivity borehole image logs. Valentin et al. simplified borehole image logs facies interpretation to four unique types of rocks (calcarenite, diabase, shale and siltstone), and each training image is associated to a single label or rock type. Valentin et al. found that some of the rock types had a similar appearance in the images, which resulted in more frequent misclassifications.

The classification method used in Valentin et al. benefited from having a very small and very distinct number of classes or rock types and using borehole image logs with a limited number of non-geological features or artefacts. Therefore, the application to automatically classifying geologic features for the purpose of hydrocarbon exploration and production is very limited due to the limited amount of granularity in the resultant classifications and limited robustness of the method to the presence of non-geological artefacts in the borehole image logs.

Feng et al. (US2020/0065606A1) disclose a method for automatically extracting geological features from electric borehole image logs. The method comprises the steps of: a) acquiring historical data of electrical (or resistivity) borehole image logs, b) pre-processing the historical data to generate a complete image of the borehole image log covering the full hole, c) recognizing and marking geological features in the image to produce pairs of training images and associated labelled geological features with the same dimensions as the training images, d) constructing a deep learning model in order to associate each pixel in the training image to a labelled geological feature, e) training the deep learning model using the images of the geological features, f) using the trained deep learning model to recognize geological features of a well section, and e) performing morphological optimization processing on the recognition results.

However, satisfactory results using the method proposed by Feng et al., can only be obtained in settings with a very large number of original training samples that are only available with a very large number of original training wells. In addition, their results are severely affected by acquisition and geomechanical artefacts that change the appearance of the borehole image logs. Accordingly, Feng et al. propose a postprocessing step to perform morphological optimization in order to correct for artefacts.

There is a need for an improved method for training a backpropagation-enabled process in order to predict the occurrence of a geological features in a borehole image log. Specifically, there is a need for improving the robustness of a trained backpropagation-enabled process by training with simulated data. There is also a need for improving the robustness of a trained backpropagation-enabled process by training for the occurrence of non-geological features.

### SUMMARY OF THE INVENTION

According to one aspect of the present invention, a method for predicting an occurrence of a geological feature in an image of a borehole image log, the method comprising the steps of: (a) providing a trained backpropagation-enabled process, wherein a backpropagation-enabled process is trained by (i) inputting a set of training images derived from simulated data into a backpropagation-enabled process, wherein the simulated data is selected from the group consisting of augmented images, synthetic images, and combinations thereof; (ii) inputting a set of labels of geological features associated with the set of training images into the backpropagation-enabled process; and (iii) iteratively computing a prediction of the probability of occurrence of the geological feature for the set of training images and adjusting the parameters in the backpropagation-enabled process, thereby producing the trained backpropagation-enabled process; and (b) using the trained backpropagation-enabled process to predict the occurrence of the geological feature in a non-training image of a borehole image log.

According to another aspect of the present invention, a method for predicting an occurrence of a geological feature in an image of a borehole image log, the method comprising the steps of: (a) providing a trained backpropagation-enabled process, wherein a backpropagation-enabled process is trained by (i) inputting a set of training images of a borehole image log into a backpropagation-enabled process; (ii) inputting a set of labels of geological features and non-geological features associated with the set of training images into the backpropagation-enabled process, wherein the non-geological features are selected from the group consisting of processing artefacts, acquisition artefacts, geomechanical artefacts, and combinations thereof; and (iii) iteratively computing a prediction of the probability of occurrence of the geological feature for the set of training images and adjusting the parameters in the backpropagation-enabled process, thereby producing the trained backpropagation-enabled process; and (b) using the trained backpropagation-enabled process to predict the occurrence of the geological feature in a non-training image of a borehole image log, wherein a distortion of the occurrence of the geological feature by the occurrence of a non-geological feature in the non-training image is reduced.

### BRIEF DESCRIPTION OF THE DRAWINGS

The method of the present invention will be better understood by referring to the following detailed description of preferred embodiments and the drawings referenced therein, in which:

FIG. 1 illustrates embodiments of the method of the present invention for generating a set of training images and associated labels for training a backpropagation-enabled process;

FIG. 2 illustrates examples of training images generated in FIG. 1 for training a backpropagation-enabled process in accordance with the method of the present invention;

FIG. 3 illustrates one embodiment of a first aspect of the method of the present invention, illustrating the training of a backpropagation-enabled process, where the backpropagation-enabled process is a segmentation process;

FIG. 4 illustrates another embodiment of the first aspect of the method of the present invention illustrating the training of a backpropagation-enabled process, where the backpropagation-enabled process is a classification process;

FIG. 5 illustrates an embodiment of a second aspect of the method of the present invention for using the trained backpropagation-enabled segmentation process of FIG. 3 to predict geological features of a non-training borehole image log; and

FIG. 6 illustrates another embodiment of the second aspect of the method of the present invention for using the trained backpropagation-enabled process of FIG. 4 to predict stratigraphic geological features of a non-training borehole image log.

### DETAILED DESCRIPTION OF THE INVENTION

The present invention provides a method for predicting an occurrence of a geological feature in an image of a borehole image log. In accordance with the present invention, a trained backpropagation-enabled process is provided and is used to predict the occurrence of the geological feature in a non-training image of a borehole image log.

### Types of Backpropagation-enabled Processes

Examples of backpropagation-enabled processes include, without limitation, artificial intelligence, machine learning, and deep-learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled processes, even if not expressly named herein.

A preferred embodiment of a backpropagation-enabled process is a deep learning process, including, but not limited to, a deep convolutional neural network.

In one embodiment of the present invention, the backpropagation-enabled process used for prediction of geological and non-geological features is a segmentation process. In another embodiment of the present invention, the backpropagation-enabled process is a classification process. Conventional segmentation and classification processes are scale-dependent. In accordance with the present invention, training data may be provided in different resolutions, thereby providing multiple scales of training data, depending on the scales of the geological features that are being trained to be predicted.

### Training Images and Associated Labels

The backpropagation-enabled process is trained by inputting a set of training images, along with a set of labels of geological features, and iteratively computing a prediction of the probability of occurrence of the geological feature for the set of training images and adjusting the parameters in the backpropagation-enabled process. This process produces the trained backpropagation-enabled process. Using a trained backpropagation-enabled process is more time-efficient and provides more consistent results than conventional manual processes.

Geological features can include, but are not limited to sedimentary structures, sedimentary facies, textures, lithologic types, and combinations thereof. For example, without limitation, the borehole image facies may be laminated, massive, mottled, vuggy, disrupted and combinations thereof. Examples of lithologic types include, without limitation, mudstones, sandstones and carbonates. Examples of textures include, without limitation, features of grains, spacing between grains, distribution of grains, and arrangement of grains of rock.

In one embodiment, the set of training images and associated labels further comprises non-geological features including, without limitation, processing artefacts, acquisition artefacts, geomechanical artefacts (such as borehole breakouts and drilling induced fractures), and combinations thereof.

One of the limitations of conventional processes to effectively train a backpropagation-enabled process is that there may not be enough variability in a set of real borehole image logs to correctly predict or identify all required types of geological features. Further, the geological features may be masked or distorted by the presence of non-geological features in borehole image logs.

Accordingly, in one embodiment of the present invention, the training images of a borehole image log are derived from simulated data. The simulated data may be selected from augmented images, synthetic images, and combinations thereof. In a preferred embodiment, the training images are a combination of simulated data and real data. The set of labels describing the geological and non-geological features can be expressed as categorical or a categorical ordinal array.

By “augmented images” we mean that the training images from a real borehole image log are manipulated by randomly modifying the azimuth, randomly flipping in the vertical direction, randomly modifying the dip by shifting the image following a sinusoid curve, randomly modifying image colors, randomly modifying intensity, randomly stretching or squeezing the vertical direction, and combinations thereof.

By “synthetic images,” we mean that the training images are derived synthetically by one of these two alternative methods:
a. Modifying a real image by overlaying synthetically generated geological features, and preferably non-geological features, manipulating a real image to remove the borehole image artefacts, manipulating a real image to add a display or graphical effect that mimics borehole image acquisition and/or processing artefacts, and combinations thereof.
b. Completely generating a synthetic image by a pattern-imitation approach, a process-based approach, and combinations thereof. A pattern-imitation approach includes, for example, without limitation, statistical methods combining stochastic random fields exhibiting different continuity ranges and types of continuity and a set of rules. A process-based approach includes, for example, without limitation, geomechanical and/or borehole stability modeling and simulation considering ambient parameters such as borehole size, present day stress, mud-weight and other relevant parameters, as well as other methods to generate synthetic images through a variety of physical relationships.

In a preferred embodiment of the method of the present invention, the backpropagation-enabled process is trained with a set of training images that include non-geological features. This provides a method that is more robust to identify geological features under the distortion or masking by different types of non-geological features or artefacts, which is common in borehole image logs. For example, any masking of the occurrence of the geological feature by the occurrence of a non-geological feature in a non-training image is reduced by training the backpropagation-enabled process with images of non-geological features. In this way, a better prediction of geological features is achieved, when applied to non-training images of borehole image logs.

### Optional Pre-processing

When the set of training images includes images of real borehole image logs and/or when the simulated data is derived from images of real borehole image logs, the images may be acquired using wireline or logging while drilling (LWD) technologies. Real borehole image logs may be pad-based or full coverage, as will be understood by those skilled in the art, and may be acquired, for example, without limitation, as acoustic, resistivity, density, gamma-ray, and/or optical borehole televiewer logs.

It may be desirable to pre-process real images before adding to the training set of images, either as real images themselves or as a basis for simulated data.

For example, pad-based image logs do not provide values for all the azimuth positions, and therefore as part of the image pre-processing, optionally, pad-based image logs can be interpolated to provide a full coverage image log. In accordance with the present invention, borehole image logs derived from synthetic data may simulate full coverage logs, pad-based logs, and/or interpolated pad-based logs.

As another example, real images may be flattened to remove structural dip. In the case of a borehole image log from a vertical well and/ having structural dips or a deviated well, the image may be flattened to a horizontal orientation.

### Types of Training Images

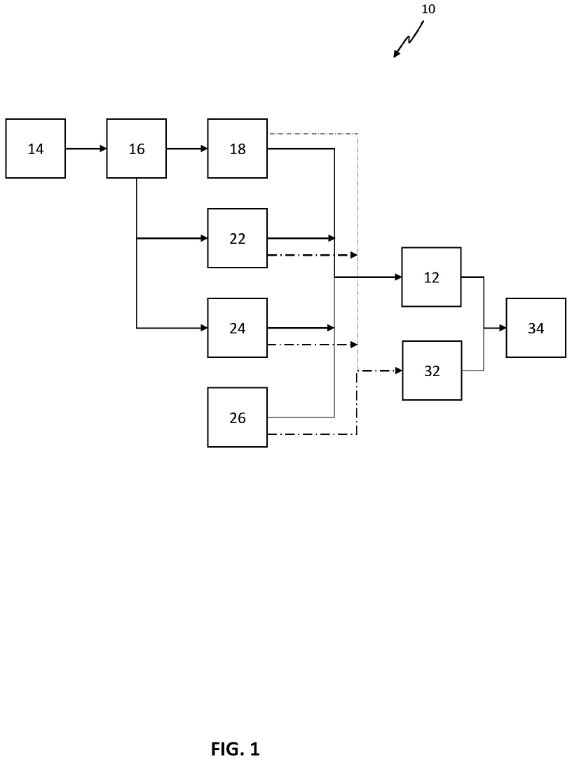

Referring now to FIG. 1, in the method of the present invention 10, a set of training images 12 is generated with images of real borehole image logs 14 and/or simulated data. The real borehole image logs 14 are optionally subjected to pre-processing 16 to flatten and/or interpolate missing values, for example, from pad-based images.

In one embodiment, the real borehole image log data 14, with or without pre-processing 16, is used to produce real training images 18. In another embodiment, the real borehole image log data 14, with or without pre-processing 16, is manipulated to generate augmented training images 22. In a further embodiment, the real borehole image log data 14, with or without pre-processing 16, is modified, as discussed above, to generate synthetic images 24. In yet another embodiment, synthetically generated images 26 are derived by means of numerical pattern-imitating or process-based simulations.

The set of training images 12 is generated from real training images 18, augmented training images 22, synthetic images 24, synthetically generated images 26, and combinations thereof. In a preferred embodiment, the set of training images 12 is generated from augmented training images 22, synthetic images 24, synthetically generated images 26, and combinations thereof. In a more preferred embodiment, the set of training images 12 is generated from images derived from simulated data selected from augmented training images 22, synthetic images 24, synthetically generated images 26, and combinations thereof, together with real training images 18. When a combination of images 18, 22, 24 and/or 26 is used, the training images are merged to provide the set of training images 12.

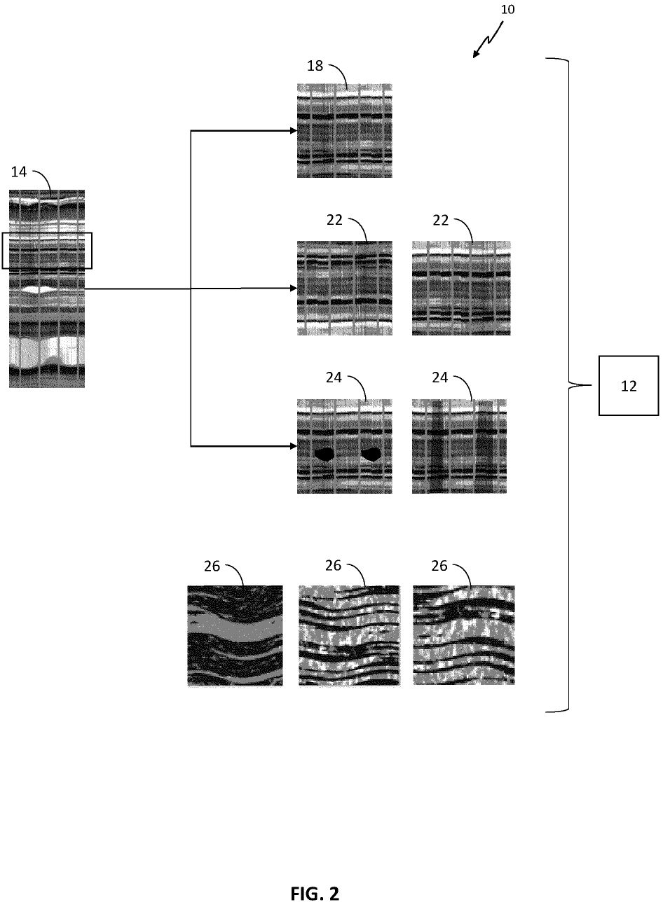

Examples of types of training images showing a laminated texture facies for training a backpropagation-enabled process in accordance with the method of the present invention 10 are illustrated in FIG. 2. Real borehole image log data 14, with or without pre-processing (not shown), may be used to produce real training images 18. Alternatively, or in addition, the real borehole image log data 14 is manipulated to generate augmented training images 22. Alternatively, or in addition, the real borehole image log data 14 is modified, as discussed above, to generate synthetic images 24. Alternatively, or in addition, the set of training images 12 is comprised of synthetically generated images 26.

Returning now to FIG. 1, a set of labels 32 associated with the set of training images 12 for geological features, preferably also non-geological features, is also generated, as depicted by the dash-dot lines in FIG. 1. In the embodiments of real training images 18 and augmented training images 22, the features are labelled manually. In the embodiment of synthetic images 24, manually assigned labels are automatically modified where appropriate. And, in the case of synthetically generated images 26, labels are automatically generated. When a combination of images 18, 22, 24 and/or 26 is used to generate the set of training images 12, the associated labels are merged to provide the set of labels 32.

In conventional processes, certain geological or non-geological features may be less common, creating an imbalance of training data. In a preferred embodiment of the present invention, the set of training data is selected to overcome any imbalances of training data in step 34. For example, where the backpropagation-enabled process is a classification process, the training data set 12 provides similar or same number of images for the classes of geological features, preferably also non-geological features. Where the backpropagation-enabled process is a segmentation process, data imbalances can be overcome by providing a similar or same number of images for each dominant class of geological features, and by further modifying the weights on predictions of classes not sufficiently represented

### Training Image Resolution and Storage

Training images derived from real borehole image logs have a resolution that, by default, is dependent on the imaging tool type, acquisition parameters, borehole condition, pre-processing steps and other parameters that are known to those skilled in the art. The number of pixels per area of the borehole image define the resolution of the training image, wherein the area defined by each pixel represents a maximum resolution of the training image. The resolution of the training image should be selected to provide a pixel size at which the desired geological features are sufficiently resolved and at which a sufficient field of view is provided so as to be representative of the borehole image sample for a given geological feature to be analyzed. The image resolution is chosen to be detailed enough for feature identification while maintaining enough field of view to avoid distortions of the overall sample. In a preferred embodiment, the image resolution is selected to require as little computational power to store and conduct further computational activity on the image while providing enough detail to identify a geological feature based on a segmented image.

Training images should have a consistent image resolution, whether they are derived from simulated data or from images of real borehole image logs.

In an embodiment of the present invention, the training images are stored and/or obtained from a cloud-based tool adapted to store images.

### Backpropagation-enabled Process Training

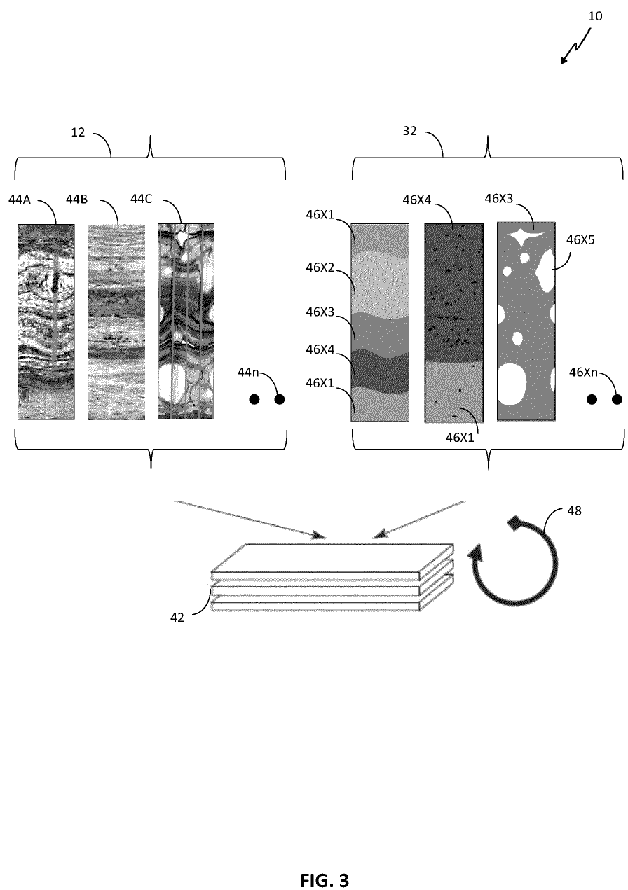

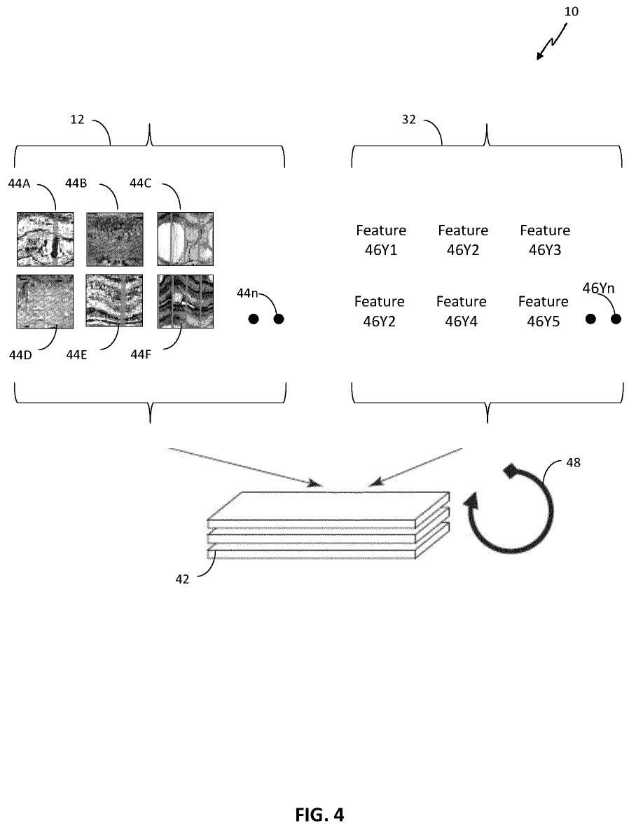

Referring now to the drawings, FIGS. 3 and 4 illustrate two embodiments of the method of the present invention 10 for training a backpropagation-enabled process 42. In the embodiment of FIG. 3, the backpropagation-enabled process is a segmentation process. In the embodiment of FIG. 4, the backpropagation-enabled process is a classification process.

The backpropagation-enabled process 42 is trained by inputting a set 12 of training images 44A - 44n, together with a set 32 of labels 46X1 - 46Xn or 46Y1 - 46 Y1n.

In the FIG. 3 embodiment, where the backpropagation-enabled process 42 is a segmentation process, the labels 46X1 - 46Xn have the same horizontal and vertical dimensions as the associated training images 44A - 44n. The labels 46X1 - 46Xn describe the presence of a geological feature for each pixel in the associated training image 44A - 44n. In a preferred embodiment, the labels 46X1 - 46Xn also describe the presence of a non-geological feature for each pixel in the associated training image 44A - 44n. In the example shown in FIG. 3, the features are present in multiple training images, for example label 46X1 identifies the same type of geological feature and therefore is denoted with the same grayscale color in the FIG. 3.

In the FIG. 4 embodiment, where the backpropagation-enabled process 42 is a classification process, a single label 46Y1 - 46Yn for each geological feature is associated with each respective training image 44A - 44n. In a preferred embodiment, the labels 46Y1 - 46Yn also include labels for non-geological features associated with the respective training image 44A - 44n. Each geological or non-geological feature is present in multiple images, for example the images in 44B and 44D identify the same type of geological feature 46Y2.

Referring to both FIGS. 3 and 4, the training images 44A - 44n and the associated labels 46X1 - 46Xn and 46Y1 - 46Yn, respectively, are inputted to the backpropagation-enabled process 42. The process trains a set of parameters in the backpropagation-enabled model 42. The training is an iterative process, as depicted by the arrow 48, in which the prediction of the probability of occurrence of the geological feature is computed, this prediction is compared with the input labels 46X1 - 46Xn or 46Y1 - 46Yn, and then through backpropagation processes the parameters of the model 42 are updated.

The iterative process involves inputting a variety of training images 44A - 44n of the geological features, preferably also non-geological features, together with their associated labels during an iterative process in which the differences in the predictions of the probability of occurrence of each geological feature, preferably also non-geological features, and the labels associated with the training images 44A - 44n are minimized. The parameters in the model 42 are considered trained when a pre-determined threshold in the differences between the probability of occurrence of each geological feature, preferably also non-geological features, and the labels associated with the training images 44A - 44n is achieved, or the backpropagation process has been repeated a predetermined number of iterations.

In accordance with the present invention, the prediction of the probability of occurrence has a prediction dimension of at least one. In the backpropagation-enabled segmentation process embodiment of FIG. 3, the prediction of the occurrence of a geological feature is the same as the image resolution in the set 12 of training images 44A - 44n.

In a preferred embodiment, the training step includes validation and testing. Preferably, results from using the trained backpropagation-enabled process are provided as feedback to the process for further training and/or validation of the process.

### Inferences With Trained Backpropagation-enabled Process

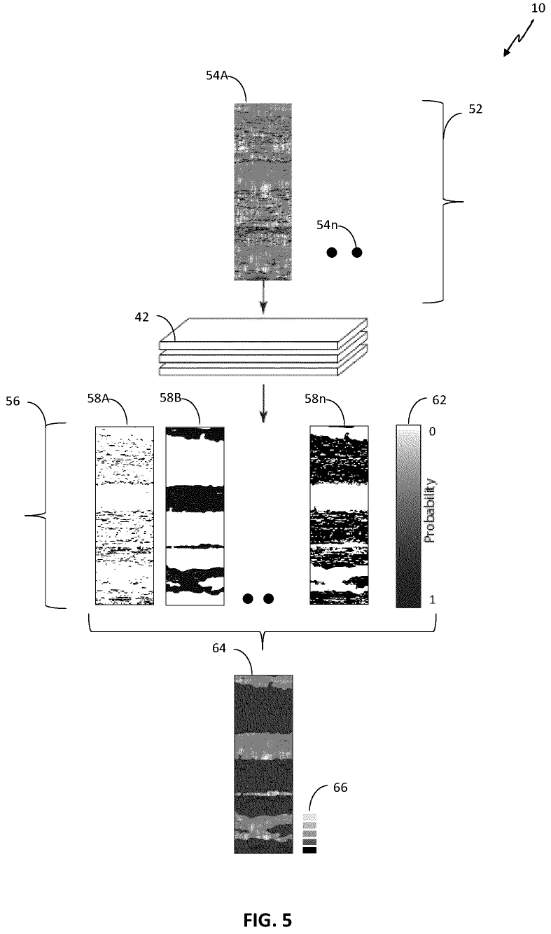

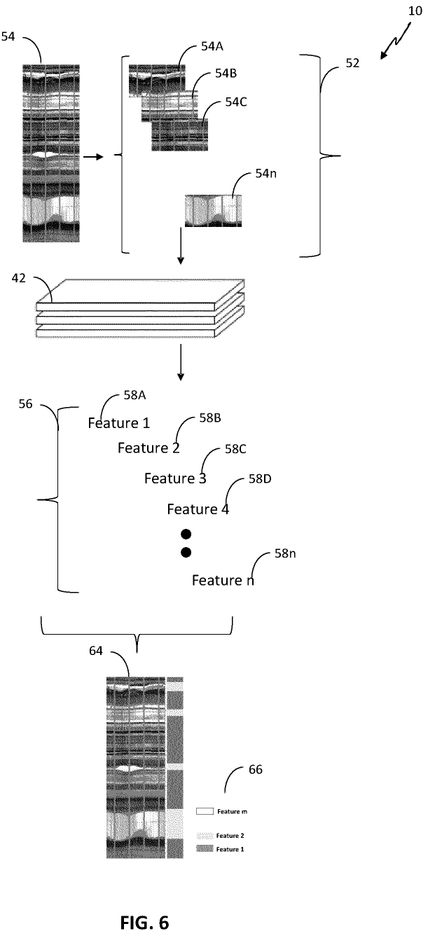

Once trained, the backpropagation-enabled process 42 is used to predict or infer the occurrence of geological features. FIG. 5 illustrates using the trained backpropagation-enabled segmentation process 42 of FIG. 3, while FIG. 6 illustrates using the trained backpropagation-enabled classification process 42 of FIG. 4.

In one embodiment, the probability of occurrence is depicted on a grayscale with 0 (white) to 1 (black). Alternatively, a color scale can be used.

Turning now to FIG. 5, a set 52 of non-training borehole log images 54A - 54n is fed to a trained backpropagation-enabled segmentation process 42. A set 56 of geological feature predictions 58A - 58n are produced showing the presence probability for each feature in 62. For example, in prediction 58A, the probability of the presence of dissolution vugs is depicted. In prediction 58B, the probability of the presence of massive texture facies is depicted, and, in prediction 58n, the probability of the presence of vuggy texture facies is depicted.

In a preferred embodiment, the set 56 of geological feature predictions 58A - 58n and presence probabilities are combined to produce a combined prediction 64 by selecting the feature with the largest probability for each pixel. Various geological features are illustrated by a color-coded bar 66.

Turning now to FIG. 6, the borehole image log 54 is subdivided into a set of non-training borehole log images 54A - 54n that are fed to a trained backpropagation-enabled classification process 42. A set 56 of geological features predictions 58A - 58n is produced for each of the images with the feature having the highest predicted presence probability.

In a preferred embodiment, the set 56 of geological feature predictions 58A - 58n are combined to produce a combined prediction 64, in which each depth of the borehole image log is associated with a predicted feature. Various geological features are illustrated by a color-coded bar 66. For example, Feature 1 describes a layered texture, while Feature 2 describes a texture dominated by concretion nodules.

While preferred embodiments of the present invention have been described, it should be understood that various changes, adaptations and modifications can be made therein within the scope of the invention(s) as claimed below.

What is claimed is:

1. A method for predicting an occurrence of a geological feature in a borehole image log, the method comprising the steps of:
(a) providing a trained backpropagation-enabled process, wherein a backpropagation-enabled process is trained by
i. inputting a set of training images derived from simulated data into a backpropagation-enabled process, wherein the simulated data is selected from the group consisting of augmented images, synthetic images and combinations thereof;
ii. inputting a set of labels of geological features associated with the set of training images into the backpropagation-enabled process; and
iii. iteratively computing a prediction of the probability of occurrence of the geological feature for the set of training images and adjusting the parameters in the backpropagation-enabled process, thereby producing the trained backpropagation-enabled process; and
(b) using the trained backpropagation-enabled process to predict the occurrence of the geological feature in a non-training image of a borehole image log.

2. The method of claim 1, wherein the set of training images further comprises images of a real borehole image log.

3. The method of claim 1, wherein the set of training images further comprises an image of a non-geological feature selected from the group consisting of processing artefacts, acquisition artefacts, geomechanical artefacts, and combinations thereof.

4. The method of claim 1, wherein the geological feature is selected from the group consisting of sedimentary structures, sedimentary facies, textures, lithologic types, and combinations thereof.

5. The method of claim 1, wherein the backpropagation-enabled process is a segmentation or a classification process.

6. The method of claim 1, wherein the borehole image logs are pre-processed.

7. The method of claim 1, wherein step (b) comprises the steps of:
i. inputting a set of non-training images of borehole image logs into the trained backpropagation-enabled process;
ii. predicting a set of probabilities of occurrence of the geological feature; and
iii. producing a prediction of occurrence of the geological feature based on the set of probabilities of occurrence.

8. The method of claim 1, wherein a result of step (b) is used to produce a set of predicted labels to further train the backpropagation-enabled process.

9. A method for predicting an occurrence of a geological feature in an image of a borehole image log, the method comprising the steps of:
(a) providing a trained backpropagation-enabled process, wherein a backpropagation-enabled process is trained by
i. inputting a set of training images of a borehole image log into a backpropagation-enabled process;
ii. inputting a set of labels of geological features and non-geological features associated with the set of training images into the backpropagation-enabled process, wherein the non-geological features are selected from the group consisting of processing artefacts, acquisition artefacts, geomechanical artefacts, and combinations thereof; and
iii. iteratively computing a prediction of the probability of occurrence of the geological feature for the set of training images and adjusting the parameters in the backpropagation-enabled process, thereby producing the trained backpropagation-enabled process; and
(b) using the trained backpropagation-enabled process to predict the occurrence of the geological feature in a non-training image of a borehole image log, wherein a distortion of the occurrence of the geological feature by the occurrence of a non-geological feature in the non-training image is reduced.

10. The method of claim 9, wherein the set of training images comprises simulated data selected from the group consisting of augmented images, synthetically images, and combinations thereof.

11. The method of claim 10, wherein the set of training images further comprises images of a real borehole image log.

12. The method of claim 9, wherein the geological feature is selected from the group consisting of borehole image facies that correlate to lithologic types, sedimentary structures, sedimentary facies, textures, and combinations thereof.

13. The method of claim 9, wherein the backpropagation-enabled process a segmentation process or a classification process.

14. The method of claim 9, wherein the borehole image logs are pre-processed.

15. The method of claim 9, wherein step (b) comprises the steps of:
iv. inputting a set of non-training borehole image logs into the trained backpropagation-enabled process;
v. predicting a set of probabilities of occurrence of the geological or non-geological feature; and
vi. producing a combined prediction based on the set of probabilities of occurrence.

16. The method of claim 9, wherein a result of step (b) is used to produce a set of predicted labels to further train the backpropagation-enabled process.
